(19) United States
(12) Patent Application Publication
(10) Pub. No.: US 2010/0315191 A1
(43) Pub. Date: Dec. 16, 2010

(54) Patterned magnetic inductors

(76) Inventors: T. Danny Xiao, Willington, CT (US); Xinqing Ma, Willington, CT (US); Steve Murphy, Willington, CT (US)

Correspondence Address: CANTOR COLBURN LLP, 20 Church Street, 22nd Floor, Hartford, CT, 06103, US

(21) Appl. No.: 11/580,798

(22) Filed: Oct. 13, 2006

Related U.S. Application Data
(60) Provisional application No. 60/726,675, filed on Oct. 13, 2005.

(51) Int. Cl. H01F 5/00; H01F 7/06

(52) U.S. Cl. 336/200; 29/607; 29/602.1

(57) ABSTRACT

A patterned inductor includes a conductive path and a nanostructured magnetic composition deposited on the conductive path. The magnetic composition can be screen printed, inkjetted, electrodeposited, spin coated, physical vapor deposited, or chemical vapor deposited onto the conductive path.

### CROSS REFERENCE TO RELATED APPLICATION

This application claims the benefit of U.S. Provisional Patent Application Ser. No. 60/726,675 filed Oct. 13, 2005, which is incorporated herein by reference in its entirety.

### STATEMENT REGARDING FEDERALLY SPONSORED RESEARCH

The United States Government has certain rights in this invention pursuant to National Science Foundation Grant Number DMI-0512262.

### BACKGROUND

The present disclosure relates to the fabrication of patterned magnetic thin-film inductors for high frequency applications.

Ultrahigh frequency magnetic inductors are not widely explored, though they hold great promise for miniaturizing power electronic devices. One reason is the lack of materials that have a high permeability and low eddy current loss at high frequencies. Three types of magnetic materials are currently used in magnetic applications, including metallic alloys that are crystalline (Fe—Si, Fe—Ni, Fe—Co-based alloys), amorphous (Fe- and Co-based amorphous alloys), and nanocrystalline (e.g., Fe—Cu—Nb—Si—B); powder materials (magnetic particles embedded in an insulator matrix; and ferrites (e.g., NiFe₂O₄, Mn—Zn- and Ni—Zn-ferrites) However, these materials cannot be used efficiently in inductors at very high frequencies. Therefore, there is a great need to produce inductors that can be used at high frequencies.

### BRIEF SUMMARY

Disclosed herein are patterned magnetic inductors and methods of manufacturing thereof.

A patterned inductor includes a conductive path and a nanostructured magnetic composition deposited on the conductive path.

A method of making a patterned inductor comprises depositing a nanostructured magnetic composition on a conductive path, wherein the depositing comprises screen printing, inkjetting, electrodepositing, spin coating, physical vapor depositing, chemical vapor depositing, or a combination comprising at least one of the foregoing.

The above described and other features are exemplified by the following figures and detailed description.

### BRIEF DESCRIPTION OF THE DRAWINGS

Referring now to the figures, which are exemplary embodiments and wherein like elements are numbered alike:

FIG. 1 schematically illustrates various embodiments of patterned micro-inductors;

FIG. 2 schematically illustrates various embodiments of a nanocomposite, comprising (a) a single phase ferrite magnetic nanoparticles, (b) magnetic nanoparticles embedded in an insulator matrix (e.g., a polymer, ceramic, ferrite nanoparticles, and the like), and (c) magnetic nanoparticles coated with an insulator (e.g., a ceramic) embedded in a ferrite matrix;

FIG. 3 schematically illustrates deposition of magnetic nanocomposites by (a) electrophoresis and (b) electroplating to form (c) a film comprising the magnetic nanocomposite;

FIG. 4 illustrates the variation of the effective anisotropy with particle-particle separation; and

FIG. 5 (a) schematically illustrates the front and back of a spiral inductor having 2, 3, 4, 5, and 6 turns or windings, (b) a photograph of the patterned spiral inductors, and (c) a photograph of the spiral inductors having a magnetic paste deposited thereon.

### DETAILED DESCRIPTION

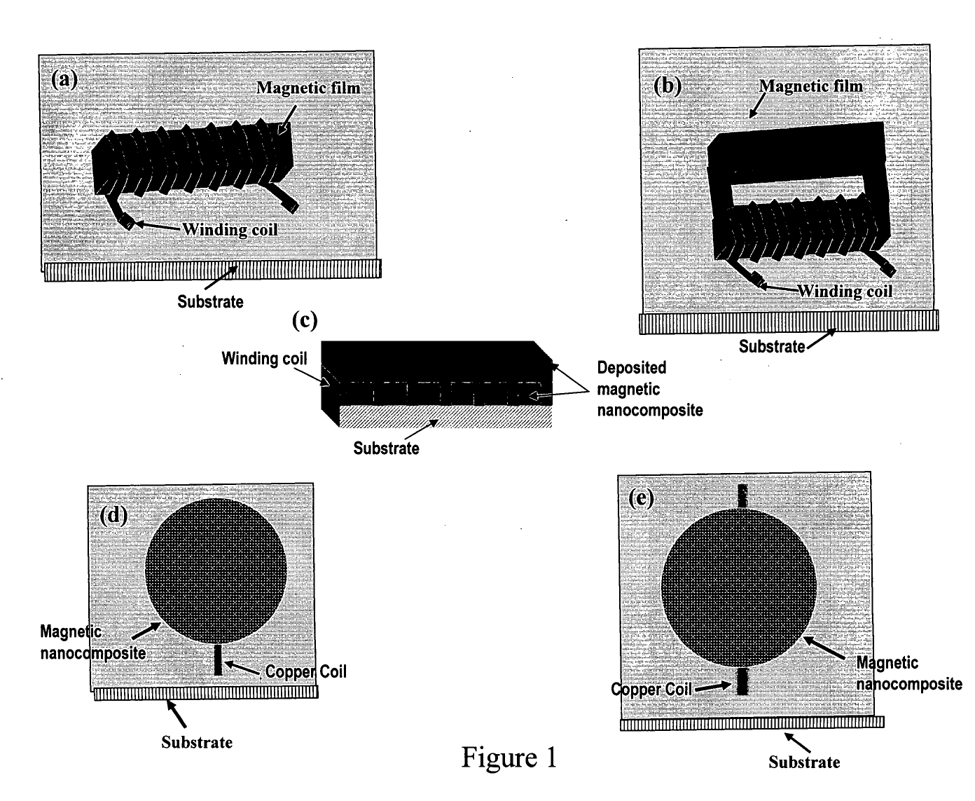

Disclosed herein are design structures of, and methods of making, patterned micro-inductors of soft nanomagnetic thin films on conductive paths in the form of metal or superconductor winding, such as shown in FIG. 1. The inductor size may be about several hundred nanometers to about 10 millimeters in dimension, with pattern (e.g., turn or winding) widths of about a few nanometers up to hundreds of micrometers.

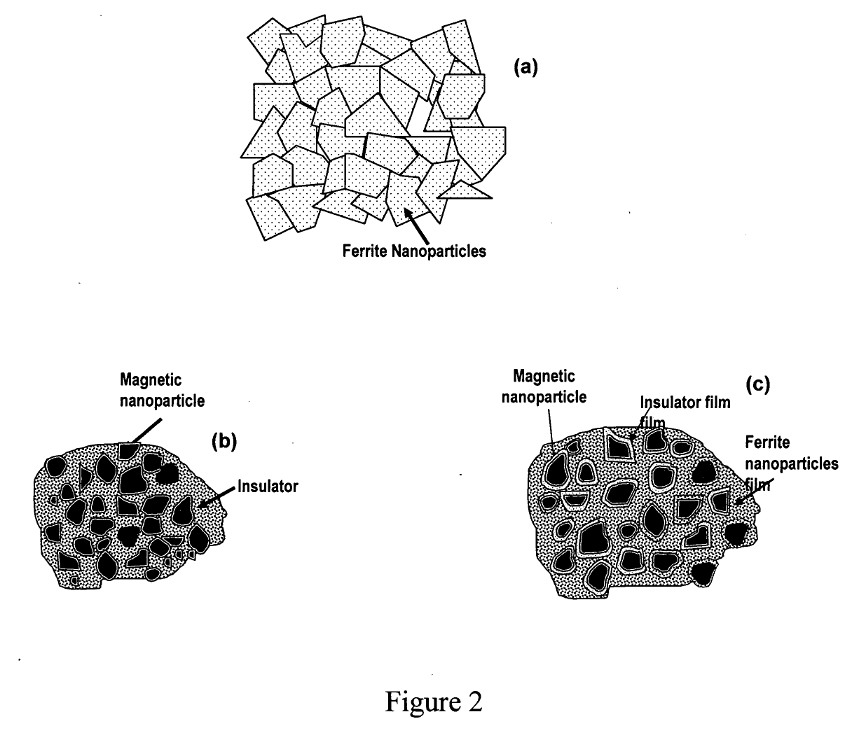

In one embodiment, there is only a single winding, where the soft magnetic film is deposited on a copper film. The soft nanomagnetic composites (also referred to as magnetic nanocomposites) used to make the magnetic film may be a single phase nanomagnetic material, e.g., a ferrite, or a multicomponent magnetic material. In the multicomponent soft nanomagnetics, the material may be (1) a two phase ferrite nanoparticles forming a nanocomposite, (2) metal nanoparticles (dispersion) uniformly distributed in ferrite nanoparticles (matrix), (3) soft magnetic nanoparticles of a metal phase (Co, or Fe) coated by an insulator (ceramic or polymer), where this coated metal phase is uniformly distributed in a ferrite matrix, as shown in FIGS. 2(a), (b), and (c), respectively.

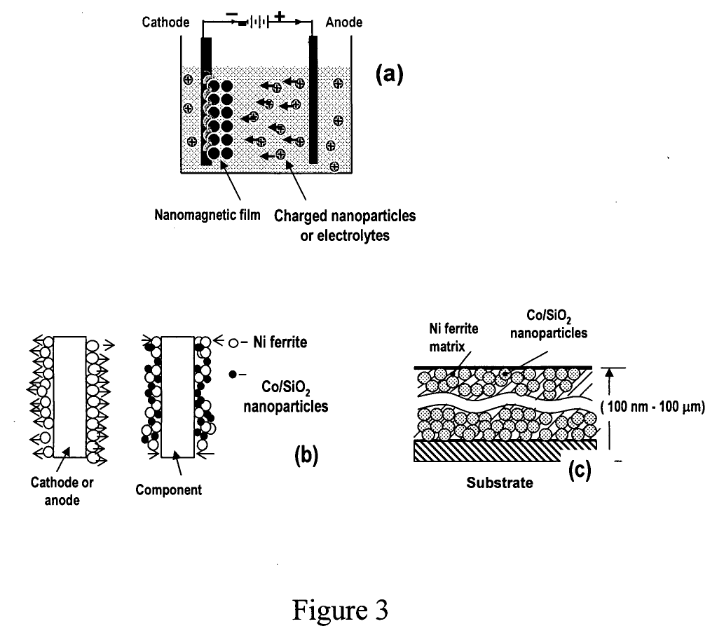

The nanostructured micro-inductors can be fabricated via different techniques, including electro or electroless deposition (as seen in FIG. 3), physical vapor deposition (e.g., sputtering, EB-PVD), paste or screen-printing, spin-coating assisted with an energy source in the form of a heater or energy beam, CVD, or sol-gel.

High frequency inductors are designed using nanomagnetic film-type materials. The advantage of using such film-type magnetic nanocomposites in a inductor design include (1) inductors being operated at high frequencies with high inductance and low losses, and (2) enabling the design of embedded inductors. In the designed inductors, films are patterned with both thin magnetic films and winding materials. Representative embedded structures are schematically illustrated in FIG. 1(a) to (e), with patterned structures ranging from squares, spirals and circular structures. Substrates can be polymeric printed circuit boards or semiconductor wafers.

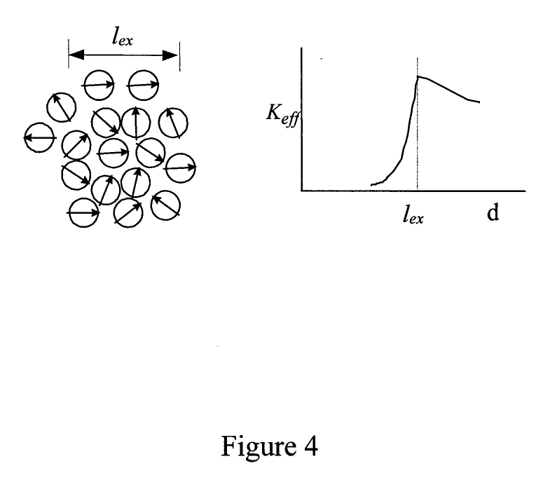

In the pattern design, the magnetic component is formed from magnetic nanoparticles, with the basic building block being nanometer-scale magnetic particles. The particles size can be varied from about 1 nanometer (nm) up to about 500 nm, depending on the domain size of the particular magnetic components, with the provision that the particle size is smaller than the size of the exchange coupling length lₑₓ, (e.g., for Co, the exchange coupling length is <50 nm, where for Fe—Ni, the exchange coupling length can be as large as about 180 nm). When the particle size is reduced to approximately lₑₓ, the intergrain exchange coupling covers the whole volume of the particle and plays a dominant role in determining the magnetic properties of the system. Particularly, when the particle-particle separation is significantly less than lₑₓ, the exchange interaction makes all the neighboring particles coupled, which leads to a cancellation of magnetic anisotropy of individual particles and the demagnetizing effect. On average, the effective anisotropy constant, K_{eff}, can be written as

$${K}_{eff} = \frac{K}{\sqrt{n}} \qquad ( 1 )$$

where K is the magnetoanisotropy constant of the magnetic particle, and n is the number of the particles within lₑₓ. FIG. 4 illustrates the variation of the effective anisotropy with particle-particle separation, d. As a consequence, the magnetic softness of the exchange-coupled nanoscale materials can be much higher than that of their bulk counterparts.

As stated above, the magnetic film can either comprise a single phase or multiphase nanocomposite. The magnetic material can include metals such as Co, Fe, Ni, or a combination comprising at least one of the foregoing, alloys and/or composites of at least one of the foregoing, which may or may not be doped (e.g., with a rare earth element such as La, Sm, Hf, Y, and the like); ferrites, such as nickel ferrites (e.g., NiFe₂O₄, (Ni—Zn)Fe₂O₄, (Mn—Zn)Fe₂O₄, and the like), cobalt ferrites (e.g., CoFe₂O₄, (Co, Hf, Y)Fe₂O₄, and the like), .iron ferrite (FeFe₂O₄), or YIG ferrite, or a combination comprising at least one of the foregoing, which may or may not be doped; a metal/insulator composite such as Co/insulator, Fe—Co/insulator, Fe/insulator, or Fe—Ni/insulator, where the insulator can be any ceramic (e.g., SiO₂, Al₂O₃, Y₂O₃, or ZrO₂, and the like), polymer (e.g., epoxy), ferrite, and/or nitride (e.g., BN, AlN, Si₃N₄, and the like); and/or a nitride (e.g., Fe₃N, Fe₄N, and Fe₁₆N₂).

The conductive path or film can be any electrically conductive material such as a metal (e.g., copper), high temperature superconductor, or conductive (i.e., metallic or semi-metallic) carbon nanotube. Suitable patterning geometries are shown in FIGS. 1(a) through (e). The thickness of the conductive path can also be varied from few nanometers up to about 3 mm. The width of the conductive film ranges from few nanometers up to 10 millimeters. In one embodiment, the inductor can be have alternating layers of magnetic component and conducting path.

The conductive path can be pre-fabricated on a substrate, simultaneously co-fabricated with the magnetic component, post-fabricated (i.e., deposited after the magnetic component), or a combination of any of the foregoing.

The patterned inductors can be fabricated via different techniques, including screen printing, inkjetting, electroplating, electrophoretic deposition, spin coating, physical vapor deposition or chemical vapor deposition.

In one embodiment, the magnetic component can be a paste that is screen-printed. Generally, the patterning of the conductive path structure is pre-fabricated. A magnetic paste comprising magnetic nanoparticles dispersed into a polymer binder is then screen-printed onto the conductive structure, or into a cavity containing the conductive path. Post-treatment, including thermal setting or radiation heating is then used to cure the polymer. After curing, a patterned solid film-type inductor is formed.

In another embodiment, the magnetic component is a paste that is inkjetted. In this case, the paste must have a sufficiently low viscosity to be sprayed through an inkjet “pen” or “nozzle”. For example, the paste can be formed by dispersing magnetic nanoparticles into a polymer or epoxy binder and subsequently diluting with a solvent. The diluted paste or “ink” is then delivered to the nozzle or pen and programmed to print the inductor. The patterning structure (conductive path) and the magnetic component can be simultaneously deposited. In this manner, detailed patterning structures can be developed and accurately deposited using a computer programmed inkjet apparatus. Post-treatment, including thermal setting or radiation heating can then be performed to cure the polymer. After curing, a patterned solid film-type inductor is formed.

As shown in FIG. 3, an electrochemical technique can be used to fabricate the inductor. Electrodeposition techniques include electroplating, electroless plating, and electrophoretic deposition.

Electroplating involves the formation of an electrolytic cell wherein a plating metal acts as one electrode, a substrate acts as the other electrode, and an external electrical charge supplied to the cell facilitates the coating of the substrate. Salts of respective elements such as Ni, Co, Fe, and/or Zn are dissolved in the plating bath along with additives to control pH and plating conditions, to form magnetic films having nanostructures. Generally, when plating metal or composite nanomagnetic films, cathodic plating is used, (i.e., magnetic nanoscale coatings are deposited onto the cathode). Besides using salts, pre-fabricated magnetic nanoparticles, such as Co/SiO₂, Fe/SiO₂, can also be dispersed into the bath to form a near-colloidal solution bath, and co-plated along with the metal (Ni, Co) or oxide (NiFe₂O₄) material. When ferrite is plated, the deposition electrode is generally the anode.

Electroless plating, which involves deposition of a coating from a bath onto a substrate by a controlled chemical reduction that is autocatalytic, can also be performed, for example to deposit a nanoscale ferrite composition.

Another technique involves depositing pre-made magnetic nanoparticles using an electrophoretic deposition technique. Here, nanoparticles are dispersed into a solution to form a colloidal solution and electrophoretic additives such as phosphors are then introduced into layers of the dispersed ferrite particles. Application of an oxide potential will then form the magnetic nanoparticles to be deposited onto a cathode.

Still other techniques to fabricate nanomagnetic inductors include sputtering, magneto-sputtering, laser ablation, electron-beam physical vapor deposition. With these techniques, nanoparticles of the final film are be used as the starting material. Evaporation of the starting material, using a high energy source such as an electro-beam, high temperature inductive heating or plasma, will result in the formation of clusters of the appropriate magnetic phase having nanoparticle dimensions. Condensation of the formed clusters on the patterned substrate will result in the formation of the patterned magnetic inductor.

Patterned films can also be achieved high speed spin coating of precursors or nanoparticles in a binder, followed by consolidation (e.g., using curing or thermal setting of the polymeric materials). For example nanocomposites of Co/SiO₂/ferrite can produced by this method.

The inductors may be employed in applications such as antennae, power converters or switching power supplies (e.g., DC-DC converters), inductors, magnetic filters, radiofrequency (RF) components, microwave and millimeter wave circulators, broadband devices, electronic sensors, cellular phones, cable television (CATV), and the like. These patterned inductors may replace the bulky donut-shaped and/or E-shaped inductors used in existing high-frequency applications.

The patterned inductors disclosed herein may have permeabilities greater than or equal to about 3 at frequencies greater than or equal to about 1 megahertz. The magnetic pastes also may have permitivities greater than or equal to about 10 and/or inductances greater than or equal to about 0.4 microHenry.

The disclosure is further illustrated by the following non-limiting examples.

### Example 1

### Patterning a Copper Conductive Path on a Silicon Wafer or Printed Circuit Board CB Substrate

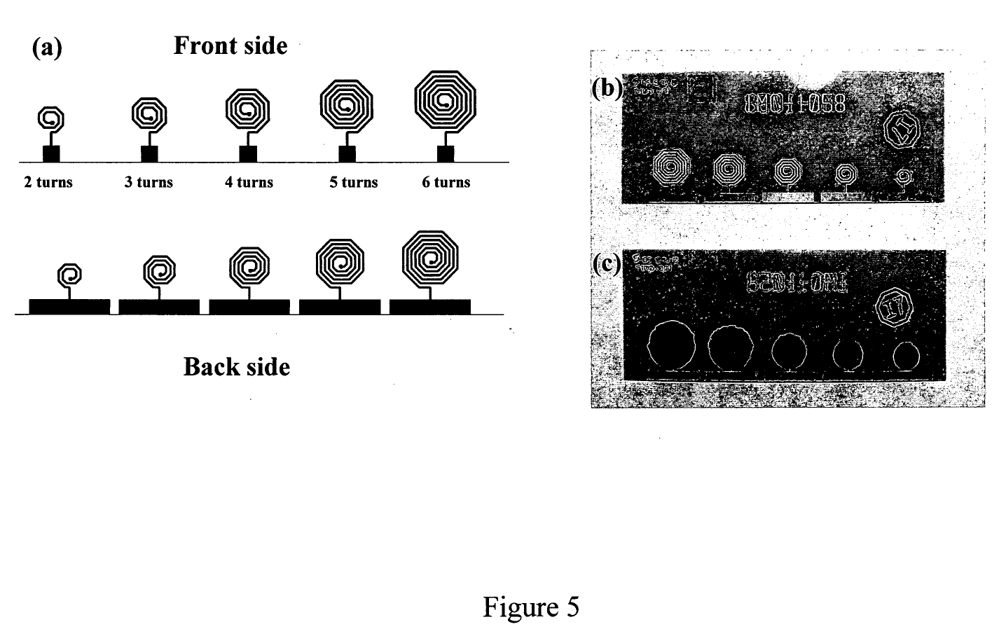

Spiral inductors were patterned on both sides of a 6 mil (152 μm) thick FR-4 substrate using 100 micrometer and 70 micrometer thick copper films. The spiral starts from one side of the FR-4 board, passes through the center of the pattern, and un-winds from the other side of the board. A test inductor had four turns on each side of the board with a trace width of about 100 to about 250 micrometers and a spacing of about 100 to about 250 micrometers. A schematic drawing of this inductor design is shown in FIG. 5(a), and the patterned structure photo in FIG. 5(b).

Similarly, spiral inductors were patterned on both sides of a 20 mil (520 μm) thick silicon wafer substrate using 100 micrometer and 70 micrometer thick copper films. The spiral starts from one side of the wafer, passes through the center of the pattern, and un-winds from the other side of the board. A test inductor had four turns on each side of the board with a trace width of about 100 to about 250 micrometers and spacing of about 100 to about 250 micrometers.

### Example 2

### Formation of Patterned Inductors by Screen Printing a Ni—Zn/Ferrite Epoxy Paste

A nanocomposite paste comprising Ni—Zn ferrite in epoxy was produced to have agglomerated particle sizes of about 1 to about 30 micrometers (individual grains of the Ni—Zn ferrite phase averaged about 50 nm). The agglomerated spheres were dispersed into an epoxy. 26 grams of plasma densified cyclone (Ni₅ₒZn₅₀)Fe₂O₄ powder having a tapping density of 2.94 was mixed with 4.27 grams of epoxy (ETC 30-3019R CLR obtained from Epoxies, ETC) by hand mixing in a beaker using a spatula. The mixing was continuously performed for 0.5 hours until a uniform paste was formed. The paste composition was 14.1 wt % epoxy with 85.9wt % (Ni₅₀Zn₅₀)Fe₂O₄ ferrite solid loading. Similarly, 20 grams of plasma densified (Ni₅₀Zn₅₀)Fe₂O₄ powder having a tapping density of 2.94 was mixed 3.5 grams of Cat 105 (obtained from Epoxies, ETC) by hand mixing in a beaker using a spatula.

Next, 10 grams of the paste formed by mixing the Ni—Zn ferrite with the ETC 30-3019R CLR was mixed with 1.6 grams of the paste formed by mixing Ni—Zn ferrite with Cat 105. After thorough mixing, the paste mixture was then screen-printed to fill a patterned structure such as that shown in FIG. 1(d), or FIG. 5(b), to form a 1 mm thick film. The epoxy was then cured at 80° C. for 5 hours, which produced a solid film.

In another trial, 20 grams of plasma densified (Ni₅₀Zn₅₀)Fe₂O₄ powder having a tapping density of 2.94 was mixed 3.5 grams of Cat 190 (obtained from Epoxies, ETC) by hand mixing in a beaker using a spatula. Next, 10 grams of the paste formed by mixing the Ni—Zn ferrite with the ETC 30-3019R CLR was mixed with 1.2 grams of the paste formed by mixing Ni—Zn ferrite with Cat 190. After thorough mixing, the paste mixture was then screen printed to fill a patterned structure to form a 1 mm thick film. The epoxy was cured after 24 hours at room temperature, resulting in a solid film.

Representative examples of the patterned nanocomposite inductors are shown in FIG. 5(c). The measured inductance for these inductors are given in Table 1 for 1 mm thick Ni—Zn ferrite/epoxy films.

TABLE 1
Inductance of the patterned inductor using 1 mm thick
Ni—Zn ferrite/epoxy film measured at 10 MHz frequency

| No of turns | Inductance (micro-Henry) |
|---|---|
| 2 | 0.1756 |
| 3 | 0.4342 |
| 4 | 0.9196 |
| 5 | 2.060 |
| 6 | 4.618 |

### Example 3

### Formation of Patterned Inductors by Screen Printing a Co/BCB Paste

Cobalt carbonyl was reduced to a Co nanoparticle dispersion at 110° C. in toluene. The average particle size of the cobalt nanoparticles were about 10 nm. Addition of benzocyclobutene (BCB) into the Co/toluene mixture resulted in the BCB coating the Co nanoparticles. A thick paste was then obtained after evaporation of the toluene under an argon atmosphere. The paste mixture was then screen-printed to fill a patterned structure such as those shown in FIG. 5(b) to form a 1 mm thick film. The BCB was then cured to form a solid film.

### Example 4

### Formation of Patterned Inductors Using Electrophoretic Deposition

In this example a silicon wafer was pre-patterned with a copper film such as shown in FIG. 1(c) using an electrplating technique.

In the electrophoretic bath preparation, 30 grams of NiFe₂O₄ nanoparticles were dispersed into 100 ml of isopropanol to make a slurry, and transferred into a small milling jar with 100 grams of zirconia beads. The samples were ball milled for about 24 hours to make a uniform colloidal solution. The colloidal solution was then transferred into a plating bath, followed by the addition of PVA, and phosphorous-containing cations. The amount of PVA and phosphorous was varied from about 1 to about 10 wt % of the ferrite depending on the bath conditions desired.

In another example, 30 grams of Co/SiO₂ nanocomposite powder was directly dispersed into 100 ml of isopropanol. In this case, nanoparticles were dispersed without the additional step of ball-milling. Electrophoretical additives, such as phosphorous or an other organic phosphor were then added to the solution. The purpose of the phosphor aadition was to functionally modify the surface of the nanoparticles with cations, so that charged nanoparticles can move toward the anode for deposition.

A patterned silicon wafer (copper) was used as the workpiece or cathode, and was surface cleaned to assure proper film adhesion strength. An electroporetic deposition process (“EPD”) was conducted to form the nanometer grained magnetic film. During the EPD process, the anode was platinum, which was inert during deposition. The distance of the electrodes was about 10 centimeters. The EPD was performed at about 5 to about 200 volts for about 5 minutes for each composition. Films obtained by this process ranged from about 10 to about 50 micrometers. The green coating was then dried at about 50° C. in an oven overnight.

In some cases, post deposition sintering was also performed. When sintering was needed, a sintering aid such as a low melting glassy phase (e.g., B₂O₃) or a high temperature polymer was used. Sintering effectively eliminated any porosity in the film.

### Example 5

### Formation of Patterned Inductors Using a Co-Electrodeposition Technique

Co/SiO₂ nanoparticles of about 20 nm was dispersed in deionized and distilled water that contained the precursor NiFe₂O₄ ingredient. Since Co/SiO₂ particles are heavy (having a density of about 6 grams per cubic centimeter for about 80% Co to 20% SiO₂), a surfactant was used to suspend these nanoparticle in water.

After preparing an electrodeposition bath, a silicon wafer patterned with copper was used as the workpiece, and was surface cleaned to assure proper film adhesion strength. A Co-electrodeposition process was conducted to form the nanometer-grained magnetic film that contains the structure shown in FIG. 2(c). During the deposition process, the other electrode was platinum, which was inert. The distance of the electrodes was about 10 centimeters. The deposited patterned film structure had a density of approximately theoretical density.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A patterned inductor, comprising:
a conductive path; and
a nanostructured magnetic composition deposited on the conductive path and in direct contact with the conductive path; where the nanostructured magnetic composition comprises a single-phase magnetic nanomaterial or a multiphase nanocomposite; the single-phase magnetic nanomaterial comprising cobalt metal, nickel metal, alloys of cobalt, alloys of nickel, or a combination thereof; and wherein the multiphase nanocomposite comprises cobalt metal, nickel metal, iron metal, alloys of cobalt, alloys of nickel, alloys of iron, or a combination thereof.

2. The patterned inductor of claim 1, wherein the conductive path is a conductive winding.

3. The patterned inductor of claim 1, wherein the nanostructured magnetic composition is a thin film.

4. The patterned inductor of claim 3, wherein the thin film is screen printed, inkjetted, electrodeposited, spin coated, physical vapor deposited, chemical vapor deposited, or a combination comprising at least one of the foregoing on the conductive path.

5. (canceled)

6. The patterned inductor of claim 5, wherein the multiphase nanocomposite comprises two ferrite phases, metal nanoparticles dispersed in a ferrite matrix, insulator coated-metal nanoparticles distributed in a ferrite matrix, or a combination comprising at least one of the foregoing.

7. The patterned inductor of claim 1, wherein the magnetic composition is a metal, alloy, ferrite, ferrite/insulator composite, or a composition comprising at least one of the foregoing.

8. The patterned inductor of claim 7, wherein an insulator of the ferrite/insulator composite is a ceramic, polymer, or resistive ferrite.

9. The patterned inductor of claim 1, wherein the conductive path has a pattern that comprises a single or a spiraling circle, an oval, a square, a rectangle, or a polygon.

10. The patterned inductor of claim 9, wherein a size of the pattern is about 1 nanometer to about 1 millimeter.

11. The patterned inductor of claim 1, wherein the magnetic composition deposited on the conductive path has a thickness of about 10 nanometers to about 3 millimeters.

12. A method of making a patterned inductor comprises depositing a nanostructured magnetic composition on a conductive path, wherein the depositing comprises screen printing, inkjetting, electrodepositing, spin coating, physical vapor depositing, chemical vapor depositing, or a combination comprising at least one of the foregoing.

13. The patterned inductor of claim 6, wherein an insulator in the insulator coated-metal nanoparticles is a ceramic, polymer, or resistive ferrite.

14. A patterned inductor, comprising:
a conductive path; and
a nanostructured magnetic composition deposited on the conductive path and in direct contact with the conductive path; where the nanostructured magnetic composition comprises metals including cobalt and/or nickel; alloys and/or composites of cobalt or nickel; alloys and/or composites of cobalt or nickel doped with a rare earth element such as lanthanum, samarium, hafnium and yttrium; nickel ferrites, cobalt ferrites, iron ferrite, yttrium iron garnet ferrite; doped nickel ferrites, doped cobalt ferrites, doped iron ferrite, doped yttrium iron garnet ferrite; a cobalt/insulator, an iron-cobalt/insulator, an iron/insulator, an iron-nickel/insulator, where the insulator is a ceramic, a polymer, a ferrite, and/or a nitride, or a combination comprising at least one of the foregoing.
